(19) United States
(12) Patent Application Publication
(10) Pub. No.: US 2009/0212077 A1
(43) Pub. Date: Aug. 27, 2009

(54) SPRAY MECHANISM

(76) Inventor: Kevin F. Carden, Bel Air, MD (US)

Correspondence Address: LAUBSCHER & LAUBSCHER, P.C., 1160 SPA ROAD, SUITE 2B, ANNAPOLIS, MD, 21403, US

(21) Appl. No.: 12/038,316

(22) Filed: Feb. 27, 2008

(51) Int. Cl. B67D 5/40

(52) U.S. Cl. 222/382; 222/377

(57) ABSTRACT

A spray mechanism for dispensing fluid from a bottle or container is characterized by a spray tube having a configuration which mirrors the front wall of the bottle. The tube is connected with a manual pump connected with the open upper end of the bottle. The lower end of the tube is terminates short of the bottom wall of the bottle and adjacent to the front wall. Accordingly, when the bottle is tilted forward, such as to spray fluid downwardly, the tube lower end is maintained submerged in the fluid, whereby the pump is operable even when the bottle is not upright in a vertical position.

### BACKGROUND OF THE INVENTION

Various types of liquid cleaning solutions are arranged in synthetic plastic containers from which the cleaning solution is dispensed by spraying. A manual pump is attached to the top of the container and a spray tube connected with the pump depends into the container and immersed in the fluid to draw fluid from the container when the pump is operated by the user.

While such devices operate satisfactorily when the container is in an upright position, they are less efficient when the container is tilted, particularly in the forward direction for directing spray downwardly. This is due to the fact that the bottom of the spray tube is removed from the cleaning fluid as the container is tilted. It then becomes necessary to pivot the container back to an upright position so that the lower end of the tube is immersed in the fluid, prime the sprayer pump, and then direct the spray to the target area. Repeated priming of the sprayer pump is annoying to the consumer, particularly where the container contains an adequate supply of cleaning fluid.

### SUMMARY OF THE INVENTION

The present invention was developed in order to overcome these and other drawbacks of the prior devices by providing a spray mechanism in which the lower end of the spray tube remains submerged in the fluid being dispensed from a container when the container is tilted. More particularly, the spray mechanism includes a manual pump adapted for connection with an open upper end of a container of fluid for pumping fluid from the container in a first direction. A spray tube is connected with the pump and has a lower end extending into the container to a position just short of a bottom wall of the container adjacent to a side wall portion of the container facing in the first direction. When the container is tilted from a vertical position in the first direction toward a horizontal position, the tube lower end remains submerged in the fluid within the container so that the pump continues to draw fluid from the container.

The tube preferably has a generally cylindrical configuration and extends parallel to the side wall portion of the container facing in the first direction. In one embodiment, the tube is part of the pump. In an alternate embodiment, the tube is integrally formed with the container and connected with the pump via a snug-fit connection.

### BRIEF DESCRIPTION OF THE FIGURES

Other objects and advantages of the invention will become apparent from a study of the following specification when viewed in the light of the accompanying drawing, in which:

FIG. 1 is a perspective view of a spray bottle incorporating the spray mechanism according to the invention;

FIGS. 2 is a sectional view of the spray bottle taken along line 2-2 of FIG. 1;

FIGS. 3 and 4 are sectional views of spray bottles incorporating spray mechanisms according to the prior art and according to the invention, respectively;

FIG. 5 is a sectional view of a spray bottle including an alternate embodiment of the spray mechanism according to the invention; and

FIG. 6 is a detailed sectional view of a portion of the spray mechanism of FIG. 5.

### DETAILED DESCRIPTION

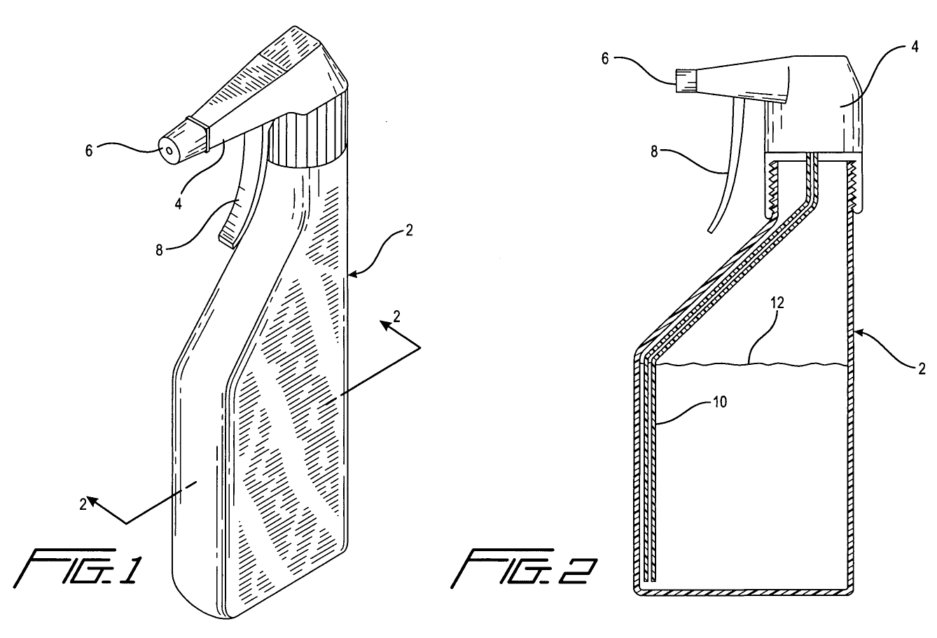

Referring to FIGS. 1 and 2, there is shown a spray container or bottle 2 incorporating the spray mechanism 4 according to the invention. The bottle is formed of synthetic plastic material and contains a fluid to be dispensed therefrom. Suitable fluids may include glass cleaner, carpet cleaner, fabric protectant, or any other fluid which is desired to spray onto a surface.

The bottle has an ergonomic design with the pump mechanism being screwed onto the open end top portion thereof in a known manner. The end of the pump mechanism has an opening 6 through which the fluid is dispensed. A trigger 8 of the pump mechanism is operable by the user to pump fluid from the interior of the bottle.

Referring to FIG. 2, there is shown a spray tube 10 which is connected with the pump mechanism. The tube is preferably formed of synthetic plastic material and has a circular cross-sectional configuration. The lower end of the tube extends to just short of the bottom wall 2a of the bottle 2. As shown in the drawing, the tube lower end is also arranged adjacent to the front wall 2b of the bottle. The front wall is defined by the direction of fluid spray exiting the opening 6 in the pump 4. With such an arrangement of the tube, there is a greater likelihood that the tube lower end will remain submerged in the fluid when the bottle is tilted. Preferably, the tube is configured with a longitudinal shape to match that of the interior surface of the front wall of the bottle so that the tube extends generally parallel to the front wall between the pump and the bottom wall.

In FIG. 3 there is shown a spray bottle 102 and pump mechanism 104 according to the prior art. As shown therein, the tube 110 extends downwardly directly from the pump, so that the tube lower end is more toward the rear of the bottle. When the bottle is tilted as shown in FIG. 3 to spray liquid in a downward direction, the lower end of the tube is above the fluid level 112 and the pump mechanism is rendered ineffective.

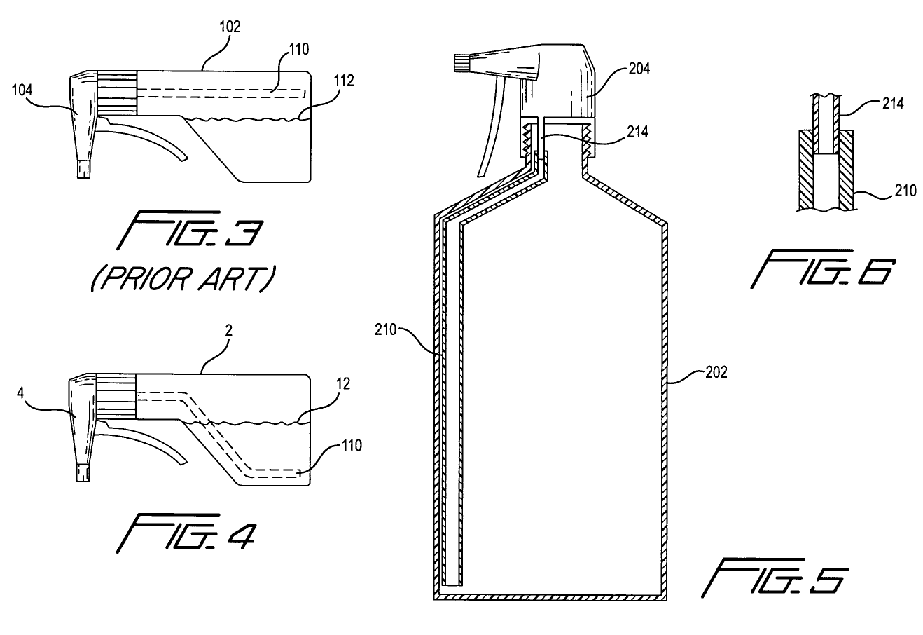

With the spray mechanism according to the invention, the lower end of the tube 10 is maintained below the fluid level 12 when the bottle is tilted as shown in FIG. 4. This arrangement ensures a continuous flow of fluid when the pump is operated by the user and eliminates the need to position the bottle upright and re-prime the pump after the bottle is tilted.

FIG. 4 illustrates and alternate embodiment of the spray mechanism according to the invention. As shown therein, the spray tube 210 is integrally formed with the bottle 202. When the pump mechanism 204 is screwed onto the top of the bottle, a projection 214 from the pump is forced into the top of the tube as shown more particularly in FIG. 6. This forms a snug fit connection between the pump and the tube so that when the pump is operated, suction is applied to the tube to withdraw fluid from the bottom of the bottle.

While the bottle of FIGS. 1, 2, and 4 is shown having an ergonomic configuration, it will be appreciated that the bottle may have other configurations as well. The bottle in FIG. 5 for example has a cylindrical configuration. Here, the tube is still arranged generally parallel to the inner surface of the front wall of the bottle.

While the preferred forms and embodiments of the invention have been illustrated and described, it will be apparent to those of ordinary skill in the art that various changes and modifications may be made without deviating from the inventive concepts set forth above.

What is claimed is:

1. A spray mechanism, comprising
(a) a manual pump adapted for connection with an open upper end of a container of fluid for pumping fluid from said container in a first direction; and
(b) a tube connected with said pump and having a lower end extending into said container to a position just short of a bottom wall of said container adjacent to a side wall portion of said container facing in said first direction, whereby when said container is tilted from a vertical position in the first direction toward a horizontal position, said tube lower end remains submerged in the fluid within the container so that said pump continues to draw fluid from the container.

2. A spray mechanism as defined in claim 1, wherein said tube has a cylindrical configuration.

3. A spray mechanism as defined in claim 2, wherein said tube extends generally parallel to said side wall portion of said container facing in said first direction.

4. A spray mechanism as defined in claim 3, wherein said tube is removably connected with said pump.

5. A spray mechanism as defined in claim 4, wherein said tube is integral with said container.
